(19) United States
(12) Patent Application Publication
(10) Pub. No.: US 2013/0199814 A1
(43) Pub. Date: Aug. 8, 2013

(54) handheld machine tool having a mechanical striking mechanism

(71) Applicants: Chuan Cheong Yew, Penang (MY); Chun How Low, Penang (MY); Chun Chee Loh, Bayan Lepas (MY); Chi Hoe Leong, Sungai Ara (MY); Mohsein Wan, Bukit Mertajam Penang (MY); Siew Yuen Lee, Pulau Pinang (MY)

(72) Inventors: Chuan Cheong Yew, Penang (MY); Chun How Low, Penang (MY); Chun Chee Loh, Bayan Lepas (MY); Chi Hoe Leong, Sungai Ara (MY); Mohsein Wan, Bukit Mertajam Penang (MY); Siew Yuen Lee, Pulau Pinang (MY)

(21) Appl. No.: 13/811,131

(22) PCT Filed: Jun. 27, 2011
(86) PCT No.: PCT/EP2011/060704

§ 371 Date: Mar. 29, 2013

(30) Foreign Application Priority Data
Jul. 19, 2010 (DE) 102010031499.4

(51) Int. Cl. B25D 17/24

(52) U.S. Cl. CPC B25D 17/24
USPC 173/211

(57) ABSTRACT

In the case of a handheld machine tool having a mechanical striking mechanism, which includes a striking body provided with at least one actuating cam and an output shaft provided with at least one output cam, the actuating cam being configured for percussively driving the output cam during percussive operation of the mechanical striking mechanism, a damping element, which has an abutment element acted upon by a spring element, is provided at least on one actuating cam and/or on one output cam.

### BACKGROUND INFORMATION

The present invention relates to a handheld machine tool having a mechanical striking mechanism that includes a striking body provided with at least one actuating cam and an output shaft provided with at least one output cam, the actuating cam being designed for percussively driving the output cam during percussive operation of the mechanical striking mechanism.

This type of handheld machine tool, designed as a rotary impact screwdriver, is known from the German Utility Model Patent DE 20 2006 014 850 U1. It has a mechanical striking mechanism having a striking body and an output shaft. During non-percussive operation of the rotary impact screwdriver, actuating cams, which are configured on the striking body, engage in output cams, which are provided on the output shaft, in a way that allows a rotary motion of the striking body to be imparted to the output shaft. During percussive operation of the rotary impact screwdriver, respectively of the striking mechanism, the actuating cams percussively drive the output cams in an assigned rotational direction; upon corresponding generation of impact, an actuating cam striking in a hammer-type action against an associated output cam.

An inherent disadvantage of the related art is that the generation of impacts during percussive operation of the striking mechanism leads to an unwanted noise generation and, thus, to loss of comfort during operation of such a handheld machine tool.

### SUMMARY OF THE INVENTION

It is, therefore, an object of the present invention to provide a novel handheld machine tool that includes a mechanical striking mechanism which will at least make it possible to reduce the noise generated during percussive operation.

This objective is achieved by a handheld machine tool having a mechanical striking mechanism that includes a striking body provided with at least one actuating cam and an output shaft provided with at least one output cam. The actuating cam is designed for percussively driving the output cam during percussive operation of the mechanical striking mechanism. A damping element featuring an abutment element acted upon by a spring element is provided on at least one actuating cam and/or one output cam.

Thus, a handheld machine tool having a mechanical striking mechanism is made possible by the present invention, whereby an unbraked striking of an actuating cam against an associated output cam during percussive operation may be readily and simply prevented by an associated damping element.

One specific embodiment provides that the spring element be a compression spring.

Thus, a simple and cost-effective spring element may be provided.

The abutment element is preferably spherical. The abutment element is preferably a steel ball.

Thus, a reliable and stable abutment element may be provided.

One specific embodiment provides for a recess to be formed on the actuating cam and/or the output cam having the damping element and for the spring element and the abutment element to be configured within the recess.

Thus, the spring element and the abutment element may be readily and simply configured on the actuating cam and/or the output cam.

The recess is preferably formed in the manner of a blind hole, whose opening is provided with an annular collar. The spring element and the abutment element are preferably configured in the blind hole in a way that allows the spring element to act upon the abutment element against the annular collar.

Thus, a simple and reliable damping element is made possible by the present invention.

The annular collar is preferably configured for blocking the abutment element in the recess.

Thus, a stable and reliable damping element may be provided.

One specific embodiment provides that the damping element be configured to at least damp a striking of the actuating cam and/or the output cam provided with the damping element against an associated output cam and/or actuating cam in order to reduce noise during percussive operation of the mechanical striking mechanism.

The objective referred to at the outset is also achieved by a mechanical striking mechanism for a handheld machine tool that includes a striking body provided with at least one actuating cam and an output shaft provided with at least one output cam. The actuating cam is designed for percussively driving the output cam during percussive operation of the mechanical striking mechanism. A damping element, featuring an abutment element acted upon by a spring element, is provided on at least one actuating cam and/or one output cam.

Thus, a mechanical striking mechanism for a handheld machine tool is provided by the present invention, whereby a striking of an actuating cam against an associated output cam during percussive operation is damped by an associated damping element, thereby making it possible to at least reduce the noise generated during percussive operation.

One specific embodiment provides for the spring element to be a compression spring and the abutment element to be a steel ball.

### BRIEF DESCRIPTION OF THE DRAWING

The present invention is explained in greater detail in the following description with reference to the exemplary embodiments illustrated in the drawing. In the drawing,

FIG. 1 shows a schematic view of a handheld machine tool having an insert tool in accordance with one specific embodiment;

FIG. 2 shows a plan view of the output shaft and the mechanical striking mechanism of the handheld machine tool of FIG. 1 in accordance with one specific embodiment, viewed in the direction of the arrows II of FIG. 1;

FIG. 3 shows a perspective view of the striking body of FIG. 2 having a partially transparent detail view of an assigned actuating cam that features a damping element in accordance with one specific embodiment;

FIG. 4 shows a perspective view of the output shaft of FIG. 2 having a partially transparent detail view of an assigned actuating cam that features a damping element in accordance with one specific embodiment; and

FIG. 5 shows a sectional view of the output cam provided with the damping element from FIG. 4 and an associated actuating cam from FIG. 2 in percussive operation.

### DESCRIPTION OF THE EXEMPLARY EMBODIMENTS

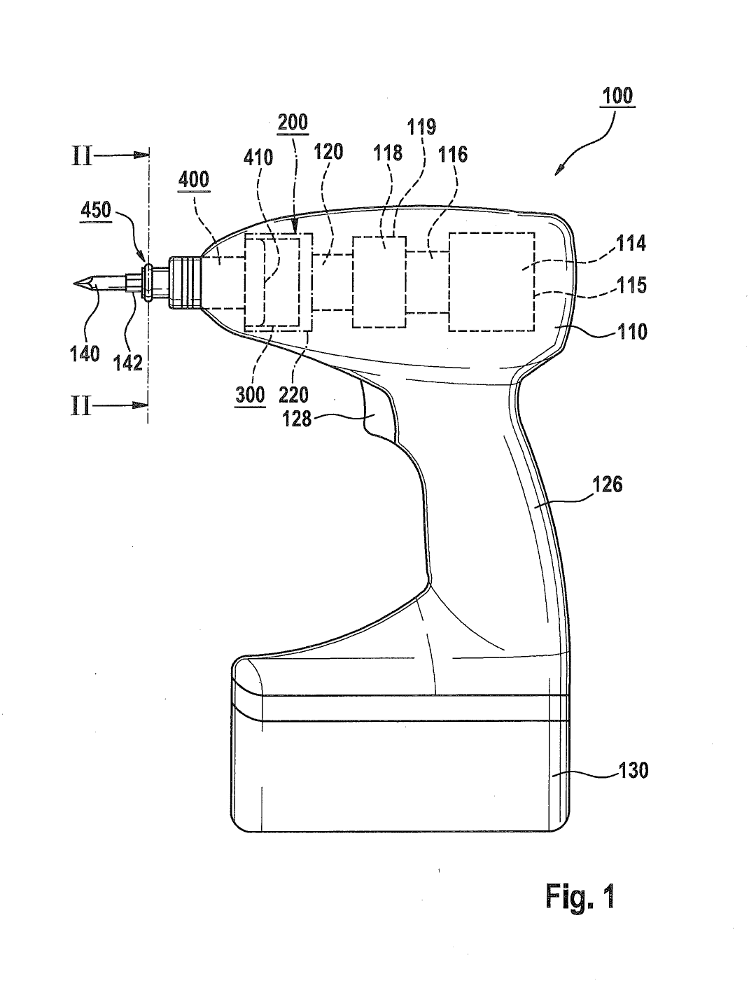

FIG. 1 shows a handheld machine tool 100 provided with a toolholder 450 and a mechanical striking mechanism 200 that features a housing 110 having a handle 126. In accordance with one specific embodiment, handheld machine tool 100 may be mechanically and electrically connected to an accumulator pack 130 for the battery-powered operation thereof.

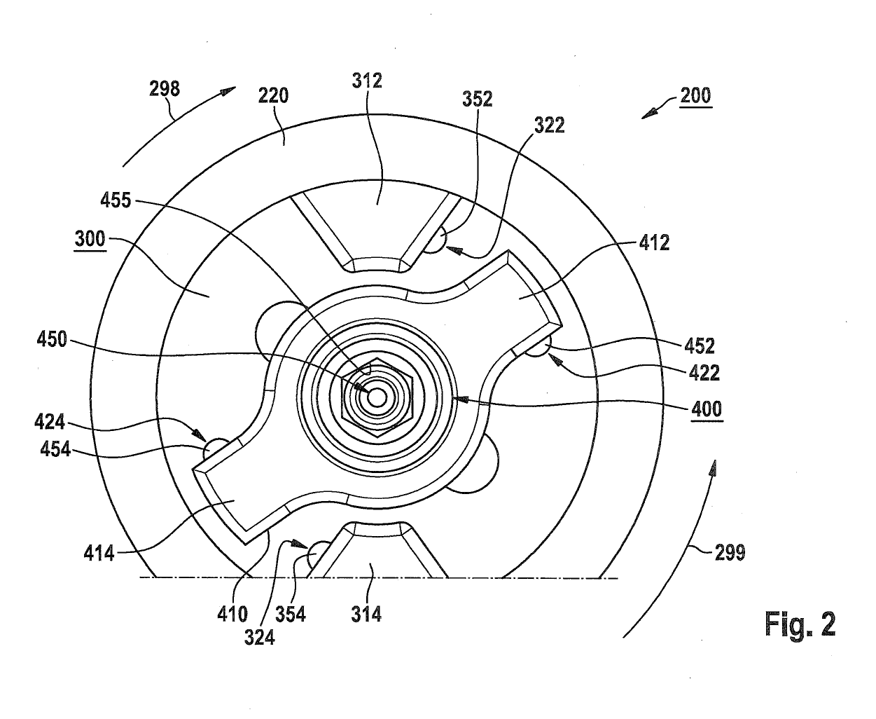

Handheld machine tool 100 is designed exemplarily as a battery-powered rotary impact screwdriver. It is noted, however, that the present invention is not limited to battery-powered rotary impact screwdrivers, but rather may be used for various power tools where a tool is set into rotation, as in the case of a percussion drill, etc., for example, regardless of whether the power tool is operated by battery power or by connection to the power supply. It is noted, moreover, that the present invention is not limited to motor-driven handheld machine tools, but may be generally used for tools that are suited for the use of striking mechanism 200 described in the context of FIG. 2 through 5.

An electric drive motor 114, which is electrically powered by battery pack 130, a gear unit 118 and striking mechanism 200 are configured in housing 110. Drive motor 114 may be actuated, for example, by a manually operated switch 128, i.e., may be switched on and off, and may be any given type of motor, such as an electronically commutated motor or a direct-current motor, for example. Drive motor 114 may preferably be electronically controlled, respectively regulated in a way that permits both a reverse operation, as well as desired rotational speed settings. The operating principle and design of a suitable drive motor are commonly known from the related art and are, therefore, not described further for the sake of conciseness of the Specification.

Drive motor 114 is linked via an associated motor shaft 116 to gear unit 118, which converts a rotation of motor shaft 116 to a rotation of a drive shaft 120 provided between gear unit 118 and striking mechanism 200. This conversion is preferably carried out in a way that allows drive shaft 120 to rotate relative to motor shaft 116 at a higher torque, but reduced rotational speed. For purposes of the illustration, drive motor 114 is configured in a motor casing 115, and gear unit 118 in a gear casing 119, gear casing 119 and motor casing 115 being configured exemplarily in housing 110.

Mechanical striking mechanism 200, coupled to drive shaft 120, is exemplarily a rotary, respectively rotational striking mechanism that is configured in an illustrative striking mechanism housing 220 that features a striking body 300 which executes rotary pulses in sudden bursts and at a high intensity and transmits the same via an output cam assembly 410 to an output shaft 400, for example, an output spindle. It is noted, however, that the use of striking mechanism housing 220 is merely presented exemplarily and is not to be understood as limiting the scope of the present invention. Rather, it may also be used for striking mechanisms that do not have a separate striking mechanism housing and are configured, for example, directly in housing 110 of handheld machine tool 100. Moreover, the operating principle and the design of a suitable striking mechanism are sufficiently known from the related art, for example, from the German Utility Model Patent DE 20 2006 014 850 U1 and, with the exception of the elements shown and described below in the context of FIG. 2 through 5, are, therefore, not described further here for the sake of conciseness of the Specification. However, reference is made explicitly here to the German Utility Model Patent DE 20 2006 014 850 U1, whose disclosure is considered to be an inherent part of the present Specification, and from which a specific embodiment of an exemplary striking mechanism may be derived.

Toolholder 450, which is preferably designed for accommodating insert tools and, in accordance with one specific embodiment, may be coupled both to an insert tool 140 having an outer polygon coupling 142, as well as to an insert tool having an inner polygon coupling, for example, a socket wrench, is provided on output shaft 400. Insert tool 140 is exemplarily in the form of a screwdriver bit having outer polygon coupling 142, illustratively a hexagon coupling, which is configured in a suitable inner mount (455 in FIG. 2) of toolholder 450. A screwdriver bit of this kind, as well as a suitable socket wrench are sufficiently known from the related art, so that, for the sake of conciseness of the Specification, no detailed description is provided.

FIG. 2 shows mechanical striking mechanism 200 of FIG. 1, including striking body 300 configured in striking mechanism housing 220 and associated output shaft 400, whose toolholder 450 is provided illustratively with an inner hexagon mount 455. In accordance with one specific embodiment, striking body 300 cylindrically formed exemplarily at the outer periphery thereof is configured rotationally and axially displaceably in striking mechanism housing 220, and output shaft 400 is configured relative to striking mechanism housing 220 rotationally, but axially immovably.

At least one actuating cam is provided on striking body 300. Two actuating cams 312, 314 are illustratively configured, for example, integrally formed on striking body 300 and, thus, joined in one piece thereto. Actuating cams 312, 314 are formed exemplarily as prism-type projections, which are directed axially relative to output shaft 400, feature approximately trapezoidal bases, and whose mutually parallel oriented, radially inner and outer sides are slightly rounded to permit adaptation to the circumference of cylindrical striking body 300. In accordance with one specific embodiment, damping elements 322, respectively 324, which feature associated abutment elements 352, respectively 354, which are illustratively spherical in shape and are preferably formed from steel balls, are provided on actuating cams 312, 314.

On output shaft 400, output cam assembly 410 is provided with at least one lateral output cam. Two lateral output cams 412, 414 are illustratively configured, for example, integrally formed on output shaft 400 and, thus, joined in one piece thereto. Output cams 412, 414 are formed exemplarily as essentially rectangular, radial extensions of output shaft 400 and feature illustratively rounded, outer corners. In accordance with one specific embodiment, damping elements 422, respectively 424, which feature associated abutment elements 452, respectively 454, which are likewise illustratively spherical in shape and are preferably formed from steel balls, are provided on actuating cams 412, 414.

Damping elements 322, 324, 422, 424 are configured in the circumferential direction of striking mechanism housing 220 exemplarily on sides of mutually opposite facing actuating cams 312, 314, respectively output cams 412, 414. In other words, damping elements 322, 324, 422, 424 are configured on actuating cams 312, 314, respectively output cams 412, 414 in a way that allows one side of an actuating cam 312, 314 or of an output cam 412, 414, provided with a damping element 322, 324, 422, 424, to face a damping element-free side of a corresponding output cam 412, 414, respectively actuating cam 312, 314.

In accordance with one specific embodiment, actuating cams 312, 314 are designed for percussively driving output cams 412, 414 during percussive operation of handheld machine tool 100 of FIG. 1, respectively of mechanical striking mechanism 200.

During non-percussive operation of striking mechanism 200, actuating cams 312, 314 serve as driving elements for output cams 414, respectively 412.

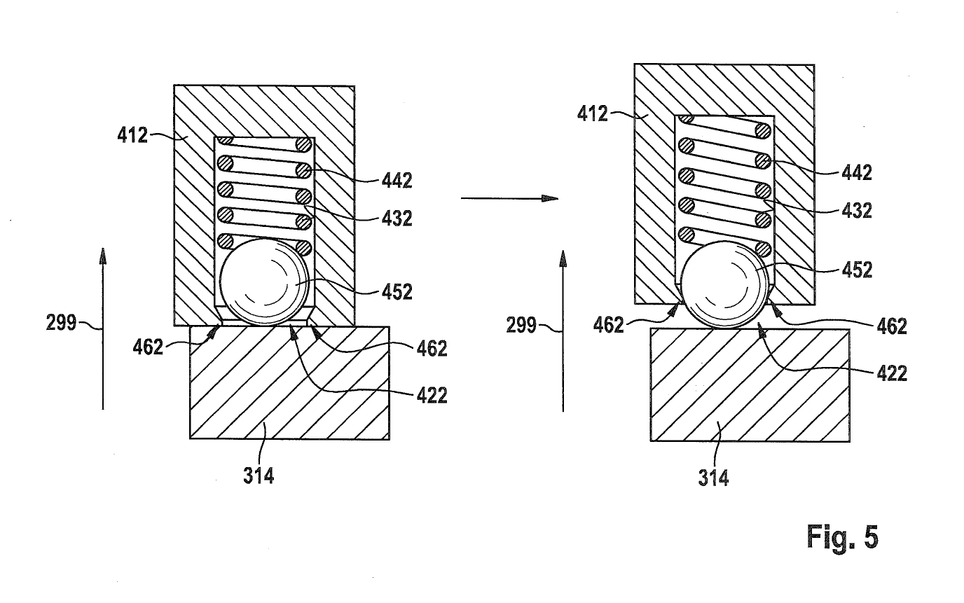

For the case that striking body 300 is set into a rotary motion in the direction of an arrow 299, for example, to generate a rotary motion of the output shaft in the direction of this arrow 299, actuating cams 312, 314 engage in output cams 414, respectively 412, and thereby impart the rotary motion of striking body 300 to output shaft 400. If, at this point, the torque requirement at output shaft 400 abruptly increases, and the rotary motion thereof is consequently blocked, striking body 300 continues to rotate in the direction of arrow 299, causing actuating cams 312, 314 to slide away over output cams 414, 412 and to be subsequently accelerated under high torque against output cams 412, respectively 414, and strike the same torsionally. In this case, the impact, respectively striking of actuating cams 312, 314 is damped by damping elements 422, 424 provided on output cams 412, respectively 414, while an associated torsional force is simultaneously transmitted to these damping elements 422, 424, as is described exemplarily below in the context of FIG. 5. Actuating cams 312, 314 subsequently slide away over output cams 412, respectively 414, etc.

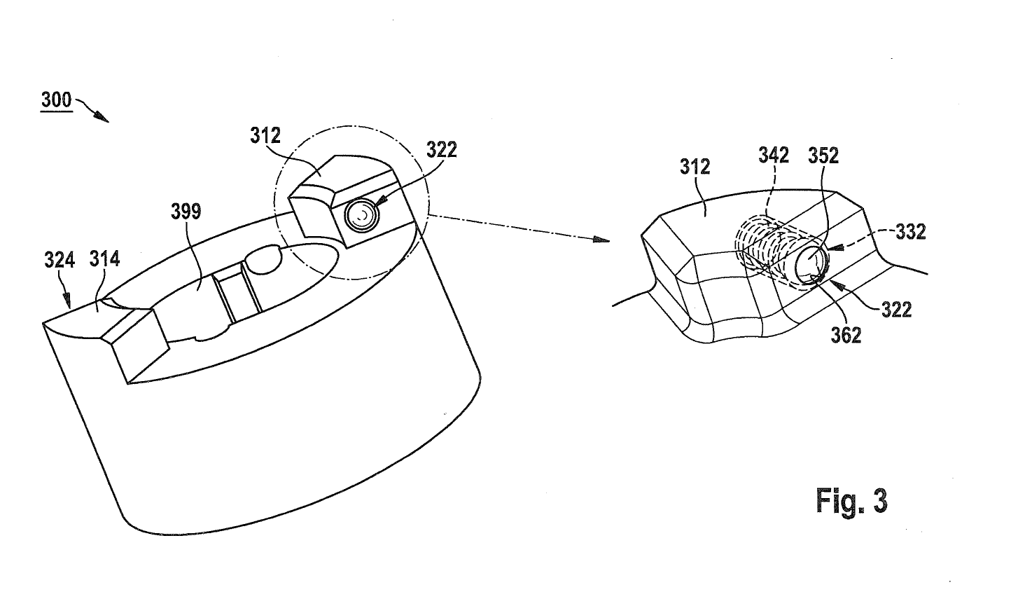

FIG. 3 illustrates striking body 300 of FIGS. 1 and 2, which is configured illustratively to include a central opening 399 for accommodating drive shaft 120 of FIG. 1. FIG. 3 illustrates an exemplary embodiment of actuating cam 312 having damping element 322. It is noted, however, that this embodiment preferably conforms with the embodiment of actuating cam 314 having damping element 324, so that, for the sake of clarity of the drawing, as well as Conciseness of the Specification, a detailed presentation or description thereof is not provided here.

To accommodate damping element 322, one specific embodiment provides for actuating cam 312 to feature a recess 332 that is illustratively formed as a type of blind hole and has an opening provided with an annular collar 362. A spring element 342, formed exemplarily as a compression spring, and steel balls 352 of FIG. 2 are mounted inside of blind hole 332 in a way that allows compression spring 342 to act upon, respectively press steel balls 352 against annular collar 362. It is noted, however, that annular collar 362 is merely presented exemplarily and is not to be understood as limiting the scope of the present invention. Rather, instead of annular collar 362, any given device may be used for restraining, respectively blocking steel balls 352 inside of blind hole 332; for example, one or a plurality of shoulder-type projections may be used for restraining steel balls 352.

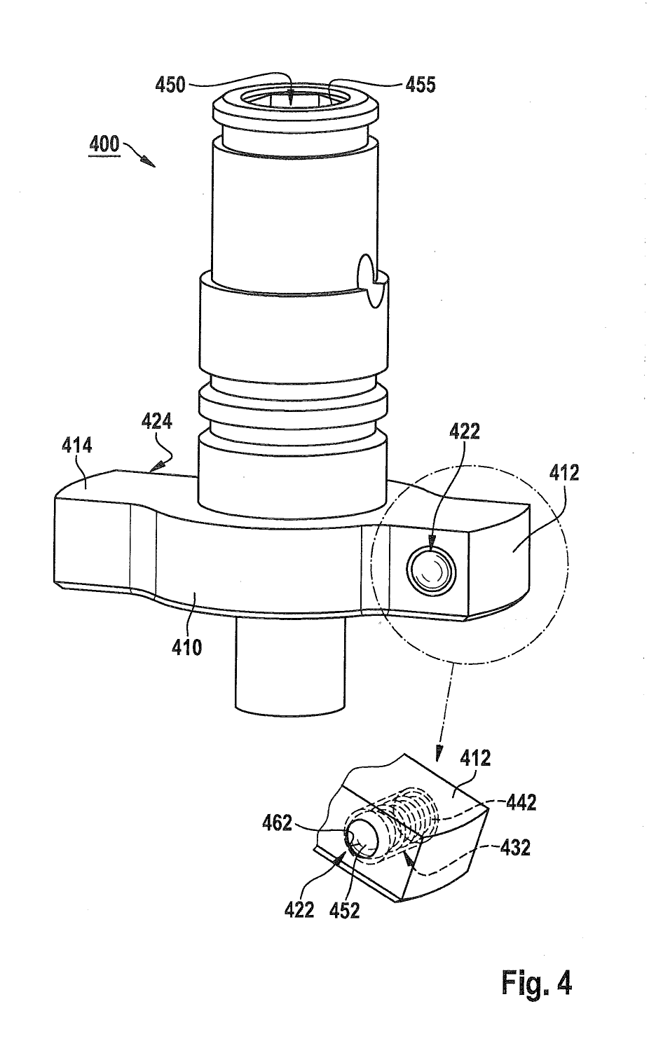

FIG. 4 shows output shaft 400 of FIGS. 1 and 2 that features toolholder 450 provided with inner hexagon mount 455 and output cam assembly 410. FIG. 4 illustrates an exemplary embodiment of output cam 412 having damping element 422. It is noted, however, that this embodiment preferably conforms to the embodiment of output cam 414 having damping element 424, so that, for the sake of clarity of the drawing as well as conciseness of the Specification, a detailed presentation or description thereof is not provided here.

To accommodate damping element 422, one specific embodiment provides that output cam 412 feature a recess 432 that is illustratively formed as a type of blind hole and has an opening provided with an annular collar 462. A spring element 442, formed exemplarily as a compression spring, and steel balls 452 of FIG. 2 are mounted inside of blind hole 332 in a way that allows compression spring 442 to act upon, respectively press steel balls 452 against annular collar 462. It is noted, however, that annular collar 462 is merely presented exemplarily and is not to be understood as limiting the scope of the present invention. Rather, instead of annular collar 462, any given device may be used for restraining, respectively blocking steel balls 452 inside of blind hole 432; for example, one or a plurality of shoulder-type projections may be used for restraining steel balls 452.

FIG. 5 shows actuating cam 314 of FIGS. 2 and 3 during interaction with output cam 412 of FIGS. 2 and 4 provided with damping element 422 during percussive operation of handheld machine tool 100 of FIG. 1, respectively of mechanical striking mechanism 200 of FIG. 2. In particular, FIG. 5 illustrates the case where a rotary motion of output cam 400 of FIG. 2 is blocked in the direction of arrow 299 of FIG. 2, and actuating cam 314 strikes against output cam 412, respectively damping element 422 thereof in the direction of arrow 299.

As is readily discernible from FIG. 5, upon striking of actuating cam 314 on damping element 422, steel balls 452 blocked at annular collar 462 are pressed into blind hole 432 against a predefinable restoring force applied by compression spring 442. Actuating cam 314 is thereby decelerated. Restoring force, which is used in the process to tension compression spring 442, corresponds approximately to a torsional force transmitted by actuating cam 314 to steel balls 452. This tensioning of compression spring 442 is limited by a striking of actuating cam 314 against output cam 412. Since this striking takes place at a reduced rotational speed of decelerated actuating cam 314, a corresponding noise generation and corresponding vibrations occurring in handheld machine tool 100 of FIG. 1 may at least be reduced.

For its part, compression spring 442, tensioned in this manner, transmits the restoring force thereof to steel ball 452, pressing it in the direction of annular collar 462. In this case, output cam 412 is pushed away from actuating cam 314 in the direction of arrow 299.

1-10. (canceled)

11. A handheld machine tool, comprising:
a mechanical striking mechanism, which includes a striking body having at least one actuating cam and an output shaft having at least one output cam, the actuating cam being configured for percussively driving the output cam during percussive operation of the mechanical striking mechanism; and
a damping element, which has an abutment element acted upon by a spring element, provided at least one of on one of the actuating cams and one of the output cams.

12. The handheld machine tool of claim 11, wherein the spring element is a compression spring.

13. The handheld machine tool of claim 11, wherein the abutment element is spherical.

14. The handheld machine tool of claim 11, wherein the abutment element is a steel ball.

15. The handheld machine tool of claim 11, wherein a recess, within which the spring element and the abutment element are configured, is formed on at least one of the actuating cam and the output cam that are provided with the damping element.

16. The handheld machine tool of claim 15, wherein the recess is formed as a type of blind hole whose opening is provided with an annular collar, the spring element and the abutment element being configured in the blind hole in a way that allows the spring element to act upon the abutment element against the annular collar.

17. The handheld machine tool of claim 16, wherein the annular collar is configured for blocking the abutment element in the recess.

18. The handheld machine tool of claim 11, wherein, to reduce noise during percussive operation of the mechanical striking mechanism, the damping element is configured for at least damping a striking of at least one of the actuating cam and the output cam provided with the damping element against at least one of an associated output cam and the actuating cam.

19. A mechanical striking mechanism for a handheld machine tool, comprising:
a striking body having at least one actuating cam and an output shaft provided with at least one output cam, the actuating cam being configured for percussively driving the output cam during percussive operation of the mechanical striking mechanism; and
a damping element, which has an abutment element acted upon by a spring element, is provided at least one of on one actuating cam and one output cam.

20. The mechanical striking mechanism of claim 19, wherein the spring element is a compression spring, and the abutment element is a steel ball.
